(19) United States
(12) Patent Application Publication
(10) Pub. No.: US 2006/0103085 A1
(43) Pub. Date: May 18, 2006

(54) Combination infant seat carrier and detachable storable stroller support structure

(76) Inventor: Alphonoso V. Sanchez, Santa Barbara, CA (US)

Correspondence Address: Daniel J. Meaney, Jr., Post Office Box 22307, Santa Barbara, CA, 93121, US

(21) Appl. No.: 10/986,648

(22) Filed: Nov. 12, 2004

(51) Int. Cl. B62B 7/12

(52) U.S. Cl. 280/30; 280/647

(57) ABSTRACT

A detachable stroller support structure for removeably receiving an infant seat carrier is shown. The structure comprises a first frame member for supporting a front wheel assembly and second frame member having a pair of ends each of which are configured to receive and support rear support wheels. The second frame member has a fixed coupling member and a first seat attachment member for attaching an infant seat carrier thereto and a moveable coupling member and a second seat attachment member for attaching an infant seat carrier thereto. At least one of the first frame member or the second frame member has a first attachment member for removeably connecting the infant seat carrier to the stroller support structure.

### CROSS-REFERENCES TO RELATED APPLICATIONS

Not Applicable

### STATEMENT REGARDING FEDERALLY SPONSORED RESEARCH OR DEVELOPMENT

Not Applicable

### REFERENCE TO A “MICROFICHE APPENDIX” (SEE 37 CFR 1.96)

Not Applicable

### BACKGROUND OF THE INVENTION

1. Field of the Invention

The present invention relates generally to strollers for infants and small children and more particularly to a combination infant seat carrier and detachable storable stroller support structure wherein a infant seat carrier adapted for use in a passenger automobile is configured to cooperate with a detachable storable stroller support structure to form a stroller comprising the infant seat carrier and a storable stroller support structure having at least one front guiding wheel and at least two rear supporting wheels. The infant seat carrier has an elevated rear control handle to enable a user to grasp, push and steer the combination infant seat carrier and detachable storable stroller support.

In the preferred embodiment, the first frame member is configured to be attached to an infant seat carrier to make the first frame member integral with the infant seat carrier. The second frame member is configured to be removeably attached to the infant seat carrier.

Another embodiment includes a first frame member which is pivotally mounted to the second frame member enabling the first frame member to be rotated relative to and positioned substantially in parallel with the second frame member to facilitate storage of the stroller support structure.

A yet another embodiment includes a first frame member which is telescopically mounted to the second frame member enabling the first frame member to be transported into and slideable within the second frame member to facilitate storage of the stroller support structure.

2. Description of the Prior Art

It is known in the art to provide a stroller assembly for use with an infant seat carrier adapted for use in a passenger automobile. The following are examples of the known prior art.

U.S. Pat. No. 6,398,233 discloses a foldable infant stroller with a separate infant seat carrier. The foldable infant stroller is foldable in both a front and side directions.

U.S. Pat. Nos. 6,302,412 and 5,499,831 disclose a foldable stroller that accepts and supports various types of child's car seats and is easily converted from its operational state to a storage state by actuating a latching mechanism. The stroller includes a lever which facilitates the removal of a child's car seat. A seat assembly can be attached to the stroller to convert the stroller from a child's car seat carrier to a toddler stroller. The seat remains in an upright position when the stroller is converted from a storage state to an operational state.

U.S. Pat. No. 6,290,892 discloses a baby stroller apparatus used in combination with a standard child's car seat. The car seat includes a transportable base having at least one transverse slot and a latching mechanism mounted retractably with the slot and releasably interengagable with a locking component in a standard fixed base mounted in a motor vehicle. The stroller includes a frame, generally parallel crossbar members and side sections. An upper crossbar is intergaged by the transverse slot in the transportable base of the car seat and releasable intergaged with a latching mechanism. A lower crossbar member is intergaged by the transportable base such that the baby's car seat is supported on and releasably locked to the frame. A plurality of wheels are rotatably mounted onto the frame.

U.S. Pat. No. 6,290,290 discloses an infant car seat support assembly for securing an infant car seat to a portable support assembly. The infant car seat support assembly includes a pair of support members. Each support member has a pair of legs and a cross member extending between upper ends of the pair of legs. The support members are pivotally coupled to each other in a manner such that the cross members are positioned in a substantially parallel relationship to each other to define an open position. Brace members are provided for holding the support members in an open position. One of the cross members is designed to securely engage an infant seat clip, whereby the infant seat support assembly can be securely engaged to the infant car seat.

U.S. Pat. No. 6,189,914 discloses a folding stroller that accepts and supports various types of child's car seats and is easily converted from its operational state to its storage state by actuating a latching mechanism. The stroller includes a lever which facilitates the removal of the child's car seat. A seat assembly can be attached to the stroller to convert the stroller from the child's car seat to a toddler stroller. The seat assembly remain in an upright position when the stroller is converted from a storage state to an operational state.

U.S. Pat. No. 5,876,046 discloses a child stroller and infant carrier system having a frame. The frame has generally parallel upstanding pylons which are secured to lower tubes with resilient locking fingers. An infant carrier is releasably coupled to the pylons to selectively join the carrier to the stroller.

U.S. Pat. No. 5,562,300 discloses a jogging stroller which includes a tricycle wheeled frame adapted for the installation of an existing vehicle child safety seat therein. The vehicle child safety seat generally include clips which are attachable to a metal rod structure. The jogging stroller includes a metal rod structure to provide for the rigid clipping of a vehicle child safety seat to the stroller frame. Relatively large removable wheels are attached to the frame in order to provider for compact storage. Removable foldable handles are provides for further compact storage.

U.S. Pat. No. 4,570,956 discloses an apparatus for converting a car seat to a stroller. The apparatus includes a framework which varies from car seat to car seat. The framework includes conventional tubing extending along the back of the framework forming a back framework portion, downwardly from each end thereof towards the front forming side-portions and along the bottom. Curved side braces are interconnected to the side portions. Front braces are interconnected to a U-shaped front tubing and a rear U-shaped tubing is secured to the back framework portion. A pair of spaced, small diameter wheels are rotatably connected to the U-shaped front portions and a pair of space larger diameter rear wheels are rotatably connect to the rear U-shaped tubing. The back frame portion may terminate in a handle support which may be formed of telescoping sections.

U.S. Pat. No. 3,738,600 discloses a universal, self-adjusting bracket that mounts a variety of plastic baby carrying seats of varying dimensions onto a portable, lightweight stroller. The stroller frame includes a bottom seat support section, a mainframe section and a lower mainframe section. A pair of front wheels are rotatably connected to the lower frame section and a single rear wheel is mounted on a short support member pivotally connected to the main frame section. The main frame section, which terminates in a handle, forms a stroller having a relatively straight frame positioned at an acute angle relative to the wheels.

U.S. Pat. Nos. 6,550,802; 6,193,263; 5,536,027; 5,234,224 and 5,188,389 disclose various stroller support structures configured for receiving and supporting a variety of baby seats or child's seats.

U.S. Pat. No. Design DES. 397,316 discloses a baby stroller support structure having a tubular bottom frame and a separate tubular upper frame that extends from the front end of the bottom frame at an acute angle and which terminates in an upwardly extending handle. The baby stroller has a single front wheel and a pair of similarly sized spaced rear wheels.

All of the prior art combination infant set and stroller support assemblies result in stroller support assemblies which are relatively large in physical size and dimension making removal and storage difficult. In addition, when a stroller support assembly is to be stored, due to the relative large size and dimensions thereof in a storage state, a relatively large storage space is required.

Also, the prior art stroller support assemblies typically comprise a single collapsible structure making the transition from a storage state to an operational state awkward for handling by the user due to the bulkiness of the structure.

### BRIEF SUMMARY OF THE INVENTION

As discussed above, numerous attempts have been made to improve the design of stroller support assemblies to reduce the difficulty of removeably attaching a vehicle infant seat carrier to a stroller support assembly and to reduce the size of the stroller support structure.

The present invention seeks to overcome the problems of the prior art by providing a stroller support structure which is configured for use with most standard vehicle infant seats. The stroller support structure of the present invention facilitates the ease of making the transition of a stroller support structure from an operational state to a storage state. When a stroller support structure is in a storage state, the physical size of the stroller support structure is minimized thereby reducing the amount of storage space required to store the stroller support structure including the wheels used therefor.

This is accomplish by using a stroller support structure which is physically smaller in size than the stroller assemblies of the known prior art and which, when in its storage state, can be stored in a smaller space usually in a passenger vehicle.

In the present invention, a detachable stroller support structure is configured for removeably receiving an infant seat carrier. The detachable stroller support structure comprises a first frame member having an end configured to receive and support a front wheel. The first frame member may have a first attachment member connected to or attached the forward portion of a seat section of an infant seat carrier. In the alternative, a second frame member may have a first attachment member positioned on the second frame member which is spaced a predetermined distance from a selected end thereof for cooperating with a second attachment member located at a predetermined location on a forward portion of a seat section of an infant seat carrier to be attached thereto.

Independent of the structure of the first frame member, the second frame member has an extended arm member having a pair of ends wherein each of the pair of ends is configured to receive and support a rear support wheel. The second frame member has a fixed coupling member positioned on the second frame member and spaced a predetermined distance from one of the pair of ends for cooperating with a first seat attachment member located at a predetermined location on a first side portion of a seat section of an infant seat carrier to be removeably attached thereto. A moveable coupling member is positioned on the second frame member and is spaced a predetermined distance from the other of the pair of ends for cooperating with a second seat attachment member located at a predetermined location on a second side portion of a seat section of an infant seat carrier.

In its broadest aspect, the stroller support structure has at least one of the first frame member or the second frame member having the first attachment member for connecting the at least one of the first frame member or the second frame member to a forward portion of a seat section of an infant seat carrier to attach the infant seat carrier thereto.

In the embodiment having the first attachment member positioned on the second frame member, the second frame member enables the first attachment member to cooperate with the second attachment member to fixedly removeably connect the infant seat carrier to the second frame member. The second frame member concurrently enables the fixed coupling member to cooperate with the first side attachment member and the moveable connecting member to cooperate with the second side attachment member to fixedly removeably connect the infant seat carrier to the second frame member.

In the preferred embodiment, the combination infant seat carrier and detachable storable stroller support has a first frame member and a second frame member. The first frame member is configured to support a front wheel and is integral with the infant seat carrier. The second frame member is configured to support two rear support wheels and has coupling members for removeably attaching the second frame member to the infant seat carrier.

In another embodiment, the combination infant seat carrier and detachable storable stroller support has a first frame member and a second frame member. The first frame member is configured to support a front wheel. The second frame member has the first attachment member positioned thereon and spaced at a predetermined location from a selected end thereof for cooperating with a second attachment member located on a forward portion of a seat section of an infant seat carrier to attach the infant seat carrier to thereto. The second frame member is configured to support two rear support wheels and has coupling members, one of which is preferably fixed and the other of which is moveable, although both coupling members could be moveable, for removeably attaching the second frame member to the infant seat carrier.

In yet another embodiment includes a combination infant seat carrier and stroller support structure wherein, upon removal of an infant seat carrier from the stroller support structure, the first frame member is pivotally mounted to the second frame member enabling the first frame member to be rotated relative to and positioned substantially in parallel with said second frame member to facilitate storage of the stroller support structure.

In still yet another embodiment includes a combination infant seat carrier and stroller support structure wherein, upon the removal of an infant seat carrier from the stroller support structure, the first frame member is telescopically mounted to the second frame member enabling the first frame member to be transported into and slideable within the second frame member to facilitate storage of the stroller support structure.

Therefore, it is an advantage of the present invention to provide a detachable stroller support structure which is configured to removeably receive and support a vehicle infant seat carrier when the infant seat carrier is removed from the stroller support structure, the stroller support structure can easily be stored.

Another advantage of the present invention is provide a combination vehicle infant seat carrier and stroller support structure wherein the stroller support structure, when in its operational state, can easily have a vehicle infant seat carrier removeably attached thereto forming a stroller using a vehicle infant set to transport a child.

Another advantage of the present invention is that the stroller support structure, when in its storage state, can have the pair of rear support wheels removed therefrom to facilitate easy storage of the stroller support structure separate from the wheels.

Another advantage of the present invention is that the stroller support structure in its preferred embodiment when in its storage state can have its front guiding wheel or front wheel assembly and its pair of rear support wheels removed therefrom to facilitate easy storage of the stroller support structure with the wheels.

Another advantage of the present inventions is that the stroller support structure in its preferred embodiment has the first frame member integral with the seat portion of the vehicle infant seat carrier. The second frame member is configured to be detachable from the vehicle infant seat carrier such that when the stroller support structure is in its storage state the front guiding wheel, the second frame member and the separate pair of rear support wheels can be stored together thereby reducing the amount of storage space required for the stroller support structure in its storage state.

Another advantage of the invention is that the stroller support structure in another embodiment has the first frame member integral with the infant seat carrier. The first frame member has the front wheel assembly having a guide wheel fixedly attached thereto while the second frame member, having a pair of spaced ends, has rear support wheels one each removeably attached to each end of the extended arm member to facilitate storage by removing the rear support wheels from the second frame for ease of storage.

Another advantage of the invention is that the stroller support structure in another embodiment has the first frame member pivotally connected with the second frame member. The first frame member has the front wheel assembly removeably attached thereto while the second frame member, having a pair of spaced ends at the ends of an extended arm member, has a rear support wheel removeably attached to each end to facilitate storage by removing the rear support wheels from the second frame. The first frame member is pivotally mounted to the second frame member enabling the first frame member to be rotated relative to and positioned substantially in parallel with said second frame member to facilitate storage of the stroller support structure.

Another advantage of the invention is that the stroller support structure in yet another embodiment has the first frame member telescopically connected with and slideable within the second frame member. The first frame member has the front wheel assembly removeably attached thereto while the second frame member, having a pair of spaced ends, has a rear support wheel removable attached to each end to facilitate storage by removing the rear support wheels from the second frame. The first frame member is slideable within the second frame member enabling the first frame member to be telescoped within the second frame member to facilitate storage of the stroller support structure.

Another advantage of the invention is that the vehicle infant seat carrier having a back section extending away from its seat section can include an elevated rear control handle enabling a user to grasp, push and steer the combination infant seat carrier and detachable stroller support assembly. When the infant seat carrier is used in a passenger vehicle, the handle may function as a protective structure.

Another advantage of the invention is that a method for attaching an infant set carrier to a stroller support structure method for using an infant set carrier with a stroller support structure is disclosed.

Another advantage of the invention is that method for attaching an infant set carrier to a stroller support structure for using an infant set carrier with a stroller support structure includes removeably attaching a front wheel to the first frame member in the preferred embodiment.

Another advantage of the invention is that method for attaching an infant set carrier to a stroller support structure for using an infant set carrier with a stroller support structure includes removeably attaching a rear support wheel to each end of the second frame member.

Another advantage of the invention is that method for attaching an infant set carrier to a stroller support structure for using an infant set carrier with a stroller support structure having the first frame member pivotally connected to the second frame member further comprising the steps of removing the infant seat carrier from the stroller support structure and rotating the first frame member relative to and positioned substantially in parallel with said second frame member to facilitate storage of the stroller support structure.

Another advantage of the invention is that method for attaching an infant set carrier to a stroller support structure for using an infant set carrier with a stroller support structure having the first frame member telescopically connected to and slideable within said second frame member further comprising the steps of removing the infant seat carrier from said stroller support structure; and sliding the first frame member relative to and within the second frame member forming a telescoped first frame member within the second frame member to facilitate storage of the stroller support structure.

### BRIEF DESCRIPTION OF THE DRAWING

The present invention will become more fully understood from the following detailed description of a preferred but non-limiting embodiment thereof, described in connection with the accompanying drawings, wherein:

FIG. 1 is a top, front and right side perspective view of a combination infant seat carrier a stroller support structure wherein the stroller support structure has a first frame member pivotally connected to the second frame member and a front wheel assembly is removeably attached to the first frame member and a rear support wheel is removeably attached to each end of the second frame member;

FIG. 2 is a top, front and right side exploded perspective view of a combination infant seat carrier a stroller support structure of FIG. 1 wherein the stroller support structure has a first frame member pivotally connected to the second frame member, has the front wheel assembly removeably attached to the first frame member and the infant seat carrier is positioned to be removeably attached to the second frame member and each of the rear support wheel are positioned to be removeably attached to each end of the second frame member;

FIG. 3 is a top, front and right side exploded perspective view of the stroller support structure shown in FIG. 1 wherein the first frame member, which is pivotally connected to the second frame member and which includes a front wheel assembly is rotated to be substantially in parallel with the second frame member, so as to position the front wheel assembly to extend away from the second frame member having the rear support wheels removed therefrom, to facilitate storage of the stroller support structure;

FIG. 4 is a top, front and right side perspective view of a combination infant seat carrier a stroller support structure wherein the stroller support structure has a first frame member having an elongated wheel support which is telescopically connected to and slideable within the second frame member to facilitate storage and wherein a front wheel assembly is removeably attached to the elongated wheel support of the first frame member and a rear support wheel is removeably attached to each end of the second frame member to facilitate use of the combination infant seat carrier stroller structure as a regular toddler stroller or as a jogging stroller;

FIG. 5 is a top, front and right side exploded perspective view of a combination infant seat carrier a stroller support structure of FIG. 4 wherein the infant seat carrier is positioned to be removeably attached to the first frame member and second frame member having a first end and a second end and each of the rear support wheels are positioned to be removeably attached to each end of the second frame member;

FIG. 6 a top, front and right side exploded perspective view of the stroller support structure of FIG. 4 wherein the first frame member, which is telescopically connected to the second frame member, has the front wheel assembly and rear support wheels removed therefrom and the frame members are in their telescope position to facilitate storage of the stroller support structure;

FIG. 7 is a pictorial representation of a second attachment member located on the front portion of a seat section of an infant seat carrier and configured to cooperate with the first attachment member located on the first frame member to facilitate connecting engagement of the infant seat carrier to the stroller support structures illustrated in FIGS. 1, 2 and 4;

FIG. 8 is a pictorial representation of a second seat attachment member located on the side portion of a seat section of an infant seat carrier and configured to cooperate with a fixed coupling member located on the second frame member to facilitate connecting engagement of the infant seat carrier to the stroller support structures illustrated in FIGS. 1, 4 and 9;

FIG. 9 is a top, front and right side perspective view of a combination infant seat carrier a stroller support structure wherein the stroller support structure has a first frame member integral with the seat and the second frame member is removeably connected to the infant seat carrier and a front wheel is removeably attached to the first frame member and a rear support wheel is removeably attached to each end of the second frame member;

FIG. 10 is a bottom, rear and right side perspective view of the combination infant set and stroller support structure of FIG. 9;

FIG. 11 is a front elevational view of the combination infant set and stroller support structure of FIG. 9;

FIG. 12 is a bottom plan view of the combination infant set and stroller support structure of FIG. 9;

FIG. 13 is a top plan view of the combination infant set and stroller support structure of FIG. 9;

FIG. 14 is a right side elevational view of the combination infant set and stroller support structure of FIG. 9;

FIG. 15 is a left side elevational view the combination infant set and stroller support structure of FIG. 9;

FIG. 16 is a top, front and right side exploded perspective view of the combination infant set and stroller support structure of FIG. 9;

FIG. 17 is a rear elevational view of an infant seat carrier showing the first frame member integral therewith and the location of a first seat attachment member on a first side portion of a seat section of an infant seat carrier to cooperate with a moveable coupling member positioned on said second frame member and a second seat attachment member located at a predetermined location on a second side portion of a seat section of an infant seat carrier to cooperate with a fixed coupling member;

FIG. 18 is a diagrammatic representation of a front view of a first frame member integral with the infant seat carrier as illustrated in FIG. 17 configured to slideably receive a front wheel frame;

FIG. 19 is a diagrammatic representation of a side view of a seat attachment member located at a predetermined location on a side portion of a seat section of an infant seat carrier to cooperate with a cooperating coupling member as illustrated in FIG. 17;

FIG. 20 is a rear elevational view of an infant seat carrier having a back section extending away from the seat section for supporting an elevated rear control handle enabling a user to grasp, push and steer the combination infant seat carrier and detachable stroller support assembly and showing by dashed lines that the elevated rear control handle is extendable to increase the distance between the back section of the infant seat carrier and the handle;

FIG. 21 is a pictorial representation of the cross-section of a tubular member configured for use as a frame member in stroller support structure of the present invention wherein the cross-section is square-shaped;

FIG. 22 is a pictorial representation of the cross-section of another form of tubular member configured for use as a frame member in stroller support structure of the present invention wherein the cross-section is circular;

FIG. 23 is a pictorial representation of the cross-section of another form of tubular member configured for use as a frame member in stroller support structure of the present invention wherein the cross-section is triangular; and

FIG. 24 is a pictorial representation of the cross-section of another form of tubular member configured for use as a frame member in stroller support structure of the present invention wherein the cross-section is oblong.

### DETAILED DESCRIPTION OF THE INVENTION

### Background

Strollers are typically used for children from infancy up to 36 months of age. The trend is to develop strollers for children 4 years and beyond. Strollers are designed for use as a normal toddler stroller for pushing a child in a walking mode. However, with the advent of running, strollers are now being designed to be used when a user is running or jogging. These strollers generally have an extended front wheel section for stability and are commonly referred to as jogging strollers.

Concurrently, infant seat carriers have been developed for use with vehicles to meet current safety requirements imposed by the Federal Department of Transportation regulations. In order to reduce the need for a variety of strollers for use in carting or transporting a child, the industry trends are to develop a stroller support structure which is configured to use a vehicle infant seat carrier as the carrier for the child and to develop stroller support structures which can be used for all of the above-described applications.

As a result of these trends, the present invention is directed to meeting a user's needs and requirements for a physically smaller stroller support structure which can be easily stored in a small storage space. The objectives are to have a stroller support structure that is mechanically easy to set up, e.g. be placed in its operating stage, a stroller support structure that is configured to have a standard vehicle infant seat carrier easily removeably attached thereto, a stroller support structure that has a front wheel which can be selectively extended to provide a stable platform for jogging and a stroller support structure that is configured to have the infant easily removed therefrom and which can easily be moved into its storage stage, e.g., collapsed position, to facilitate storage.

In describing the invention below with respect to the various figures, common elements illustrated in each of the figures are identified with the same numerals.

### Combination Infant Seat Carrier and Storable Stroller Support Structure

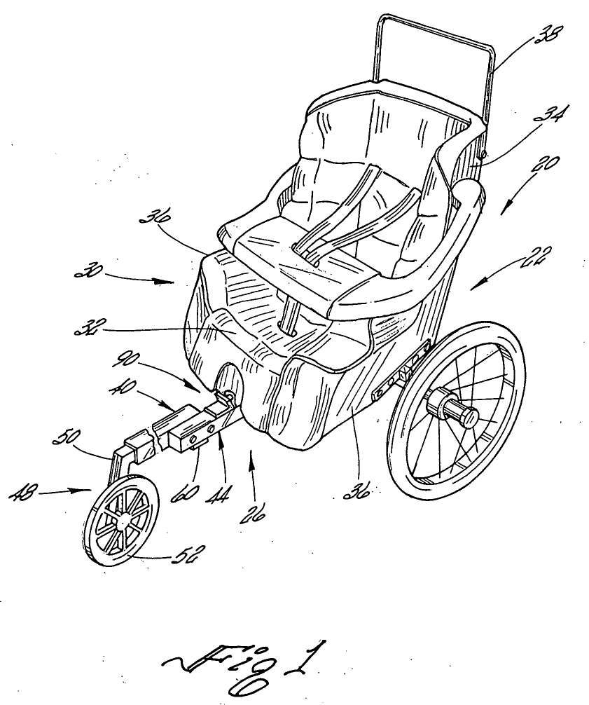

In the perspective view of FIG. 1, a combination and stroller support structure is shown generally by arrow 20. The combination infant seat carrier and stroller support structure 20 includes a vehicle infant seat carrier shown generally by arrow 22 and a stroller support structure shown generally by arrow 26.

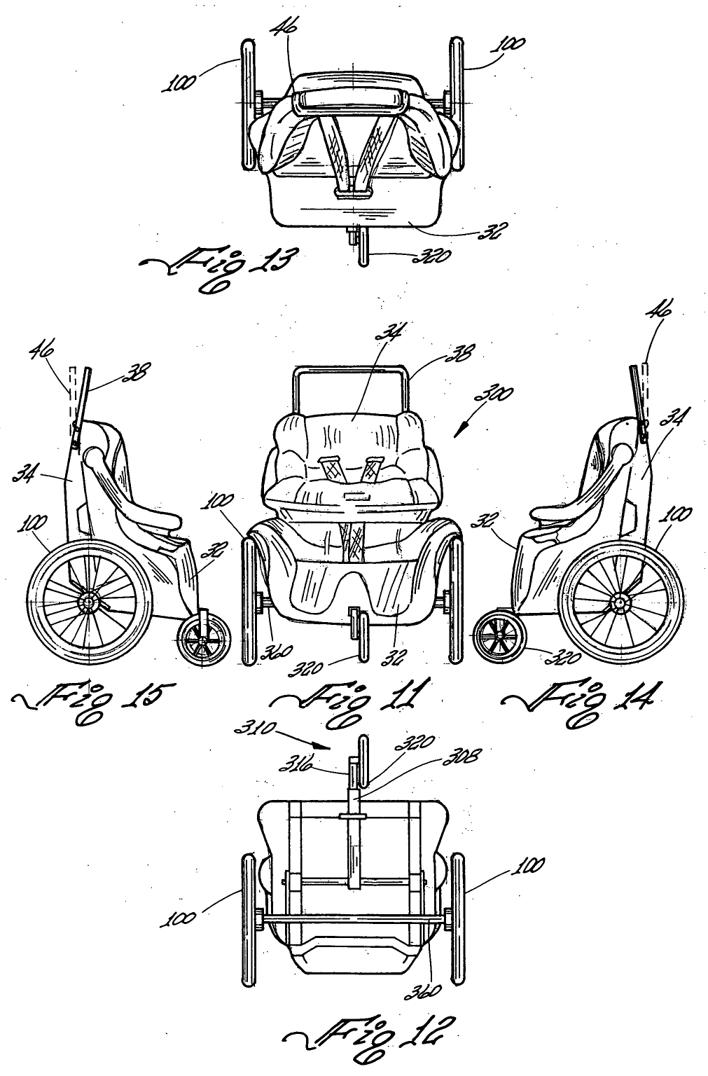

The infant seat carrier 22 has a seat section shown by arrow 30 having a forward portion 32 and a pair of opposed side portions 36 one located on each side of the seat section 30. The pair of opposed side portions 36 are sometimes referred to herein as first side portion of a seat section 30 and a second side portion of seat section 30. The infant seat carrier 22 has a back section 34 extending upwardly away from the seat section 30. The back section 34 has an elevated rear control handle 38 fixedly connected thereto to enable a user to grasp, push and steer the combination infant seat carrier and detachable stroller support assembly 20. The elevated rear control handle 38 may have telescoping support members to permit the user to adjust the height or angle of the elevated rear control handle 38 as depicted by dashed line 46 in FIGS. 14, 15 and 20.

The stroller support structure 26, in the embodiment of FIGS. 1 through 3, has a first frame member 40 pivotally connected to a second frame member 44. The first frame member 40 has a front wheel assembly shown generally as 48 removeably attached thereto. The front wheel assembly 48, in the embodiment of FIGS. 1 through 3 has a front wheel support member 50, which is removeably attached to the first frame member 40. The front wheel support member 50, fixedly supports a front guide wheel 52 to steer the stroller support structure 26 and the infant seat carrier 22 removeably attached thereto. The front wheel support member 50 may have an extended length to position the front wheel 52 forward of the infant seat carrier 22. For example, the front wheel support 50 may have a length similar to the length of the frame support member 206 as shown in FIG. 4. The extended length enables the combination infant seat carrier 22 and stroller support structure 26 to function as a jogging stroller with additional stability being provided by a front wheel support member 50 having an extended length.

As shown in greater detail in FIG. 2, the front frame member 40 may include an extended support tab 60 to provide further structural rigidity to the first frame member 40 when the same is rotated into alignment with the second frame member 44 as illustrated in FIG. 2.

As shown in FIG. 2, the first frame member 40 is pivotally mounted or pivotally connected to the second frame member 44 by a pivot pin 62. The pivot pin 62 enables the first frame member 40 to be rotated relative to and to be positioned substantially in parallel with the second frame member 44. When the first frame member 40 is rotated about the pivot pin 62 and is positioned substantially in parallel with the second frame member 44, the extended support tab 60 engages the under portion of the second frame member 44 to provide structural rigidity to stroller support structure 26. A spring-loaded locking pin 70 is then passed through a locking aperture in the second frame member 44 as illustrated in FIG. 2 to lock the first frame member 40 with the second frame member 44.

In the embodiment shown in FIG. 2, the second frame member 44 is in the form of “T” shaped structure having a leg section or elongated central body 80 which is rigidly connected to the center of an extended arm section 82 having a pair of ends 86 and 88.

The first frame member 40 has an end 54 having a central opening configured to receive and support a front wheel assembly 48. In this embodiment, the second frame member 40 has a first attachment member, shown generally by arrow 90, positioned thereon and spaced a predetermined distance from the end of the second frame member 44. The first attachment member 90 cooperates with a second attachment member 100 located at a predetermined location on the forward portion of the seat section 32 of an infant seat carrier 22 to be removeably attached to the stroller support structure 26. The first attachment member 90 is preferably in the form of an extended boss member 120.

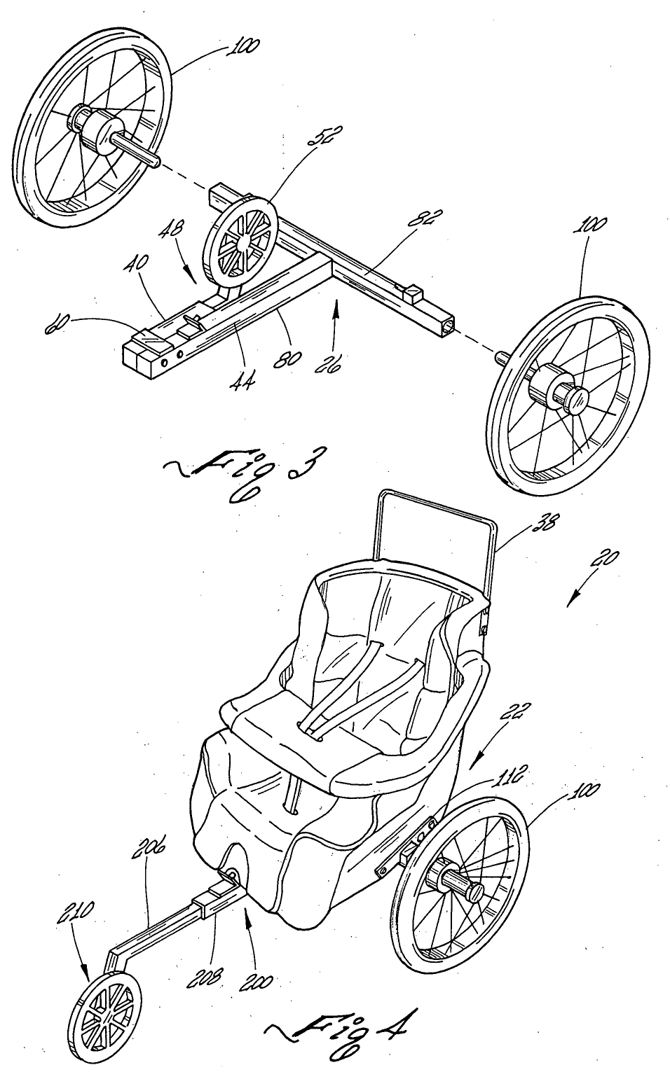

The structural details of the second attachment member 102 are shown in greater detail in FIGS. 5 and 7.

The second frame member 44 has on the elongated central member 80 a pair of ends 86 and 88 each of which is configured to receive and support a rear support wheel 100. The second frame member 44 has a fixed coupling member 104 having an extended coupling boss 128 positioned on the arm section 82 and spaced a predetermined distance from one of the pair of ends 86 for cooperating with an opening 110 formed in the first seat attachment member 112 located at a predetermined location on one of the side portions 36 of the seat section 32 of the infant seat carrier 22. The fixed coupling member 104 extended coupling boss 128 engaging cooperates with the opening 110 of the first seat attachment member 112 to removable connect the associated side portion 36 of the seat section 32 of the infant seat carrier 22 to the arm portion 82 of the second frame member 44.

A moveable coupling member 106, which is spring loaded, is positioned on the extended arm member 82 of the second frame member 44 and is spaced a predetermined distance from the other of the pair of ends 88. The moveable coupling member 106 has an extended coupling boss 126. The moveable coupling member 106 cooperates with an opening in a second seat attachment member 114 located at a predetermined location on the other of the pair of the side portions 36 of the seat section 32 of the infant seat carrier 22. The spring loaded moveable coupling member 106 is moveable along a path parallel to the extended arm member 82 of the second frame member 44 as depicted by arrow 116 to facilitate locking and unlocking of the moveable coupling member 106 with the second seat attachment member 114.

The moveable coupling member 106 is moved in a direction towards end 88 which is against the spring resistance to enable the seat section 32 of the infant seat carrier to come into supporting engagement with the arm section 82 of the second frame member 44. When the seat section 32 if the infant seat carrier 22 is in position, the moveable coupling member 106 is released and the an extended coupling boss 126 comes into engaging connect with the opening formed in the second seat attachment member 114 to removable connect or lock the associated side portion 36 of the seat section 32 of the infant seat carrier 22 to the arm portion 82 of the second frame member 44.

As a result of the above-described stroller support structure, the first frame member 40 enables the first attachment member 90 having an extended boss member 120 to cooperate with the second attachment member 100 in the form of an aperture 122 in the second attachment member 102 is sized to receive the extended boss member 120 to fixedly connect the infant seat carrier 22 to the first frame member 40.

The second frame member 44 concurrently enables the fixed coupling member 104 to cooperate with the first side attachment member 112 to removeably connect or attach the seat section 32 of the infant seat carrier to the second frame member 44. When the fixed coupling member 104 is in locking or connecting engagement with the first seat attachment member 112, the extended boss member 128 thereon cooperates with an opening 110 formed in the second side attachment member 112 to removeably connect, attach or lock the infant seat carrier 22 to the second frame member 44.

The moveable coupling member 106 is moveable relative to the arm section 82 of the second frame member 44 along the path depicted by arrow 116 between an open position and locked position. When the moveable coupling member 106 is in its locked position, the extended boss member 126 thereon cooperates with an opening formed in the second side attachment member 114 to removeably connect or attach the infant seat carrier 22 to said second frame member 44.

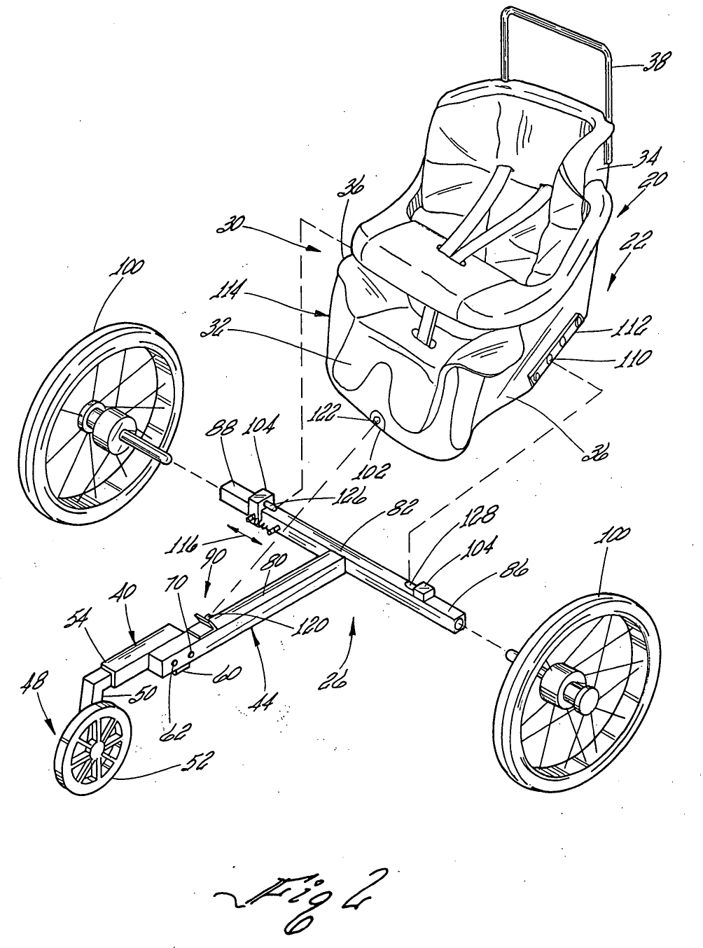

In FIG. 3, which is a top, front and right side exploded perspective view of the stroller support structure shown in FIG. 1, the first frame member 40 is pivotally connected to the second frame member 44. The first frame member 40 has been rotated to be positioned substantially in parallel with the second frame member 44 to facilitate storage of the stroller support structure 26. The front wheel assembly 48, having a front wheel 52 in a fixed position, is positioned on the first frame member 40 so as to extend away from the second frame member 44 having the rear support wheels 100 removed therefrom. This is the storage state to facilitate storage of the stroller support structure.

FIG. 4 shows another embodiment of a combination infant seat carrier a stroller support structure which incorporates the teachings of the present invention. This embodiment is illustrated as top, front and right side perspective view of a combination infant seat carrier and a telescoping embodiment of a stroller support structure 200 for supporting an infant seat carrier 22 which is of the same structure of the infant seat carrier illustrated in FIGS. 1 and 2. In the combination infant seat carrier and telescoping embodiment stroller support structure stroller 200 of FIG. 4, the stroller support structure 200 has a first frame member 206, which functions as an extended front wheel support member, and a second frame member 208. The first frame member 206 includes a front wheel assembly 210 removeably connected to the first frame member 206 which functions as an elongated front wheel support. The first frame member 206 is sized to be telescopically connected to and slideable within the second frame member 208. This structure enables the first frame member 206 to be slideable within the second frame member 208 to place the stroller support structure 200 into a storage state from its operational state and to facilitate storage there of in a telescoped arrangement. The front wheel assembly 210 may be removeably separated from or slideably telescoped within the first frame member 206 to facilitate storage.

When stroller support structure 204 is in its operational state, the exposed length of the first frame member 206 can be varied. The first frame member 206 can have: (i) an extended position as shown in FIG. 4 to facilitate use of the combination infant seat carrier and stroller support structure 200 as a jogging stroller; or (ii) a normal position by being positioned to have an exposed length such as at a exposed length depicted in FIG. 1 to facilitate use of the combination infant seat carrier and stroller support structure 200 as a normal stroller for carting a child.

If desired, the first frame member 206, having the front wheel assembly 210 removeably attached thereto, can be removed from the second frame member 204 to facilitate storage.

In the exploded perspective view of FIG. 5, the combination infant seat carrier a stroller support structure 200 of FIG. 4 is shown in greater detail. The stroller support structure 200 has a second frame member 206 wherein the infant seat carrier 22 is positioned to be removeably attached thereto. The leg section or elongated central member 80 has one attached to the center of the extended arm member 82 having a pair of ends 86 and 88, sometimes referred to herein as the first end and a second end of the second frame member. Each of the rear support wheels 100 are positioned to be removeably attached to each end of each of the pair of ends 86 and 88 of the second frame member 206.

FIG. 6 illustrates a storage position for the stroller support structure 200 wherein the first frame member 206 is telescopically slid within the second frame member 208. The structure of frame member 208 is similar to that of the second frame member 44 of FIG. 3 and has a leg 80 and a pair of ends 86 and 88.

In the alternative and as shown by phantom wheel support assembly 130′ having the front wheel shown by 52′ the front wheel assembly 130 having front wheel 52 can be removed from the second frame member 208 for storage.

The rear support wheels 100 are removed from the second frame member 208 to facilitate storage of the stroller support structure whether the front wheel assembly 130 is telescopically positioned within the second frame member 208 or removed therefrom as depicted by phantom wheel assembly 130′ having the front wheel 52′ rigidly connected thereto.

FIG. 7 illustrates the structural details of the second attachment member 122 having an opening 102 located on the front portion of a seat section of an infant seat carrier 22. The second attachment member 122 having an opening 102 is configured to cooperate with the first attachment member 90 having an extended boss member 120 located on the second frame member 44 to facilitate removeable connecting engagement of the infant seat carrier 22 to the stroller support structures 26 illustrated in FIGS. 1 through 6.

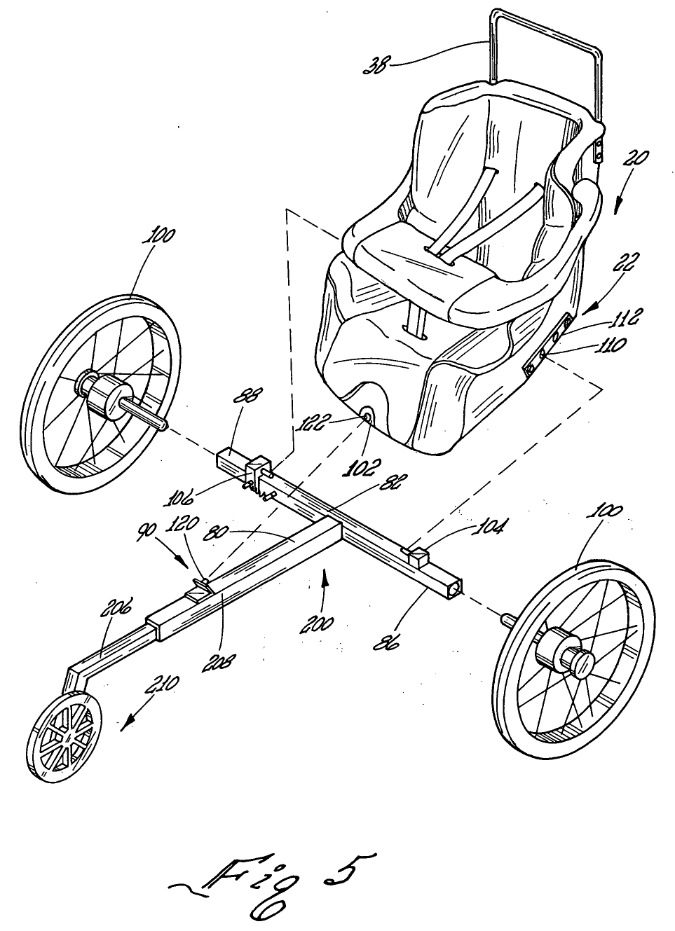

In FIG. 8, the second seat attachment member 112 is located on the side portion of a seat section of an infant seat carrier 22. The second attachment member is configured to cooperate with a fixed coupling member 104, shown in FIG. 2, located on the second frame member 44 to facilitate connecting engagement of the infant seat carrier 22 to the stroller support structures illustrated in FIGS. 2, 4, 5 and 9;

In FIG. 9, the combination infant seat carrier and a stroller support structure is shown generally by arrow 300. The stroller support structure shown generally by arrow 304 has a first frame member 360 integral with the infant seat carrier 22. The second frame member 308 is removeably connected to the infant seat carrier 22 and a front wheel assembly 310 is removeably attached to the first frame member 308. A rear support wheel 100 is removeably attached to each end of the second frame member 360.

A front wheel assembly 316 includes a front wheel support frame member 310 for rigidly supporting a front guide wheel 320.

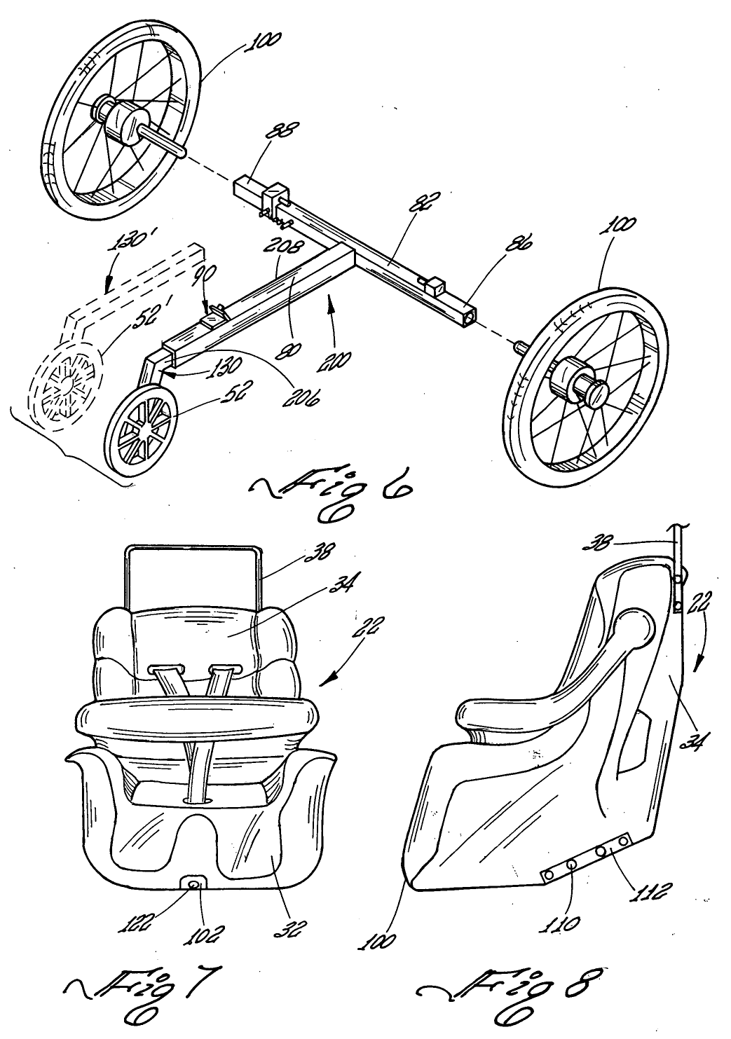

In FIG. 10, the second frame member 360 is illustrated as being removeably attached to the infant seat carrier 22. As illustrated in FIGS. 9 and 10, the infant seat carrier 22 is attached using the first and second seat attachment members 112 and 114, respectively, which are shown in FIG. 2. This is shown in greater detail in FIG. 16 as discussed below.

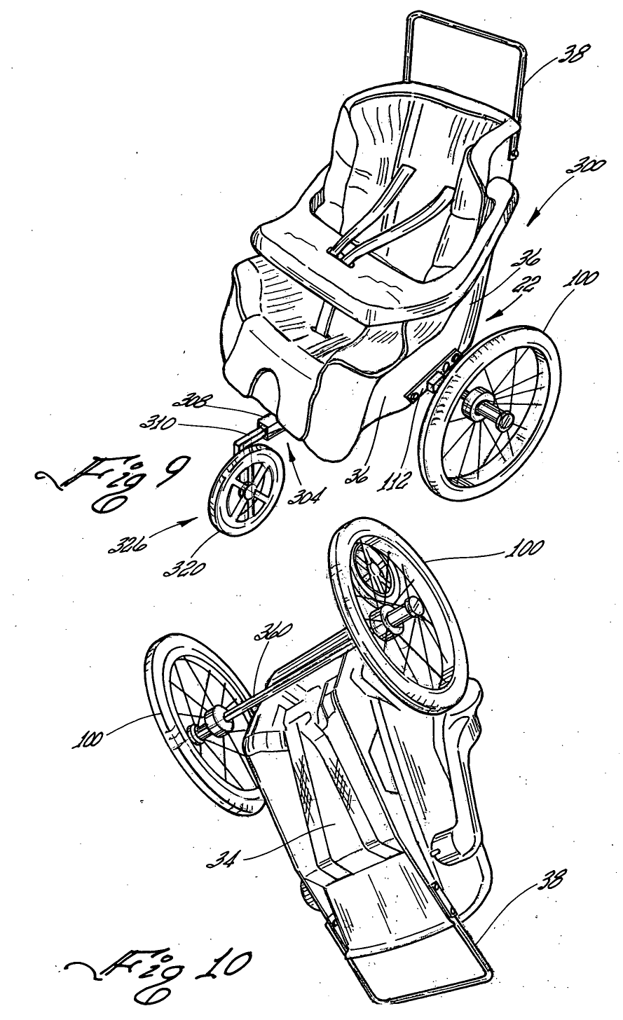

FIGS. 11 through 15 show the details of the first frame member 308 being removeably attached to the seat section 32 of the infant seat carrier 22. The second frame member 360 is likewise shown being attached to the seat section 32 of the infant seat carrier 22. The front wheel assembly 316 includes the front wheel support frame member 310 for rigidly supporting a front guide wheel 320 and the front wheel assembly is illustrated as being removeably attached to the first frame member 308 by sliding the front wheel support frame member 310, which is appropriately sized to be received by the opening of the first frame member 308, into the first frame member 308.

Thus, depending on the embodiment of the combination infant seat carrier and stroller support structure, the frame member having the first attachment member can be either the first frame member or the second frame member. In such event, at least one of the first frame member or the second frame member having a first attachment member is used for connecting the at least one of the first frame member or the second frame member to a forward portion of a seat section of an infant seat carrier to attach the infant seat carrier thereto.

In the top, front and right side exploded perspective view of the combination infant set and stroller support structure of FIG. 16, the structural details of the first frame member 308 is illustrated and shows that the first frame member 308 is integral with the seat section 32 of the infant seat carrier 22. The front wheel assembly 316 is shown with the front wheel support frame member 310 aligned for insertion as depicted by dashed line 390.

The second frame member 360 is configured to be removeably attached to the infant seat carrier 22 by a fixed coupling member 372 having an extended coupling boss 374 and a moveable coupling member 378 having an extended coupling boss 380. The fixed coupling member 372 and a moveable coupling member 378 function in a similar manner to the fixed coupling member 104 and moveable coupling member 126 shown in FIG. 2.

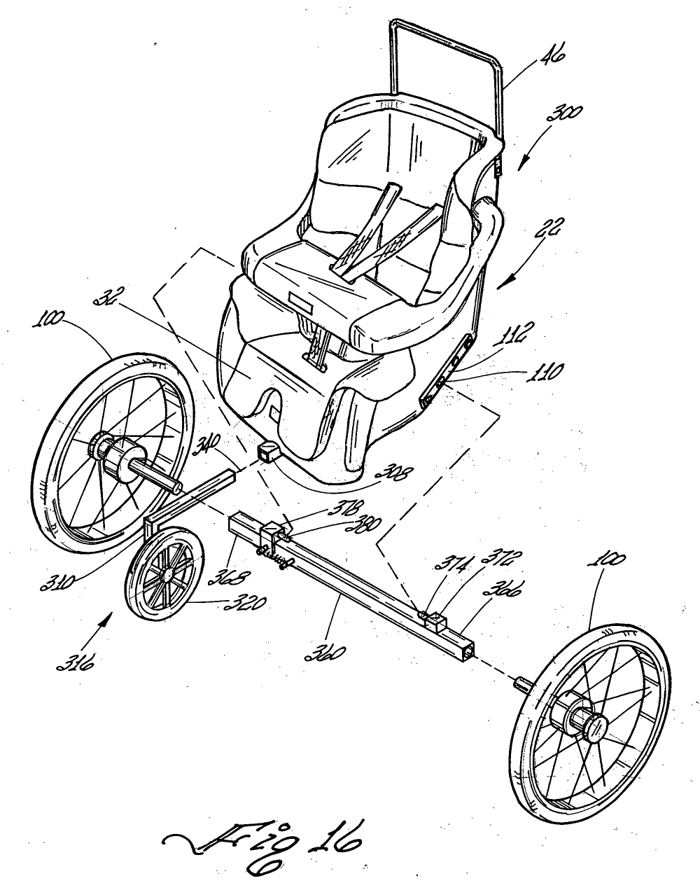

FIG. 17 illustrates in a rear elevational view the infant seat carrier 22 having the first frame member 308 attached thereto by use of a mounting strap 410 which extends from the forward portion of the seat section to the first frame member 308. The innermost end of the first frame member 308 is affixed to the infant seat carrier 22 by a fastener 412.

The first frame member 308 is essentially integral with the infant seat structure. By adding these components to an infant seat carrier, most infant seat carriers can be adapted or configured to be removeably attached to or installed onto a stroller support structure as described herein.

In FIG. 17, a first seat attachment member 112 and a second seat attachment member 114 are shown as being attached to the infant seat carrier by fasteners 420.

FIG. 18 illustrates in a diagrammatic representation of a front view of a first frame member 308, integral with the infant seat carrier as illustrated in FIG. 17, that the first frame member 308 is attached to the infant seat carrier 22 by use of the mounting strap 410 which extends from the forward portion of the seat section to the first frame member 308. The first frame member 308 is configured to slideably receive the front wheel assembly 316 which includes the front wheel support frame member 310 for rigidly supporting a front guide wheel 320 by physically sliding the front wheel support frame member 310 into the opening of the first frame member 308.

In FIG. 19, the diagrammatic representation illustrates a side view of a first seat attachment member 112 having an opening 110 sized to receive an extended boss member, similar to that illustrated by the extended boss member 374 of FIG. 16, to removeably connect the infant seat carrier 22 to the second frame member 360.

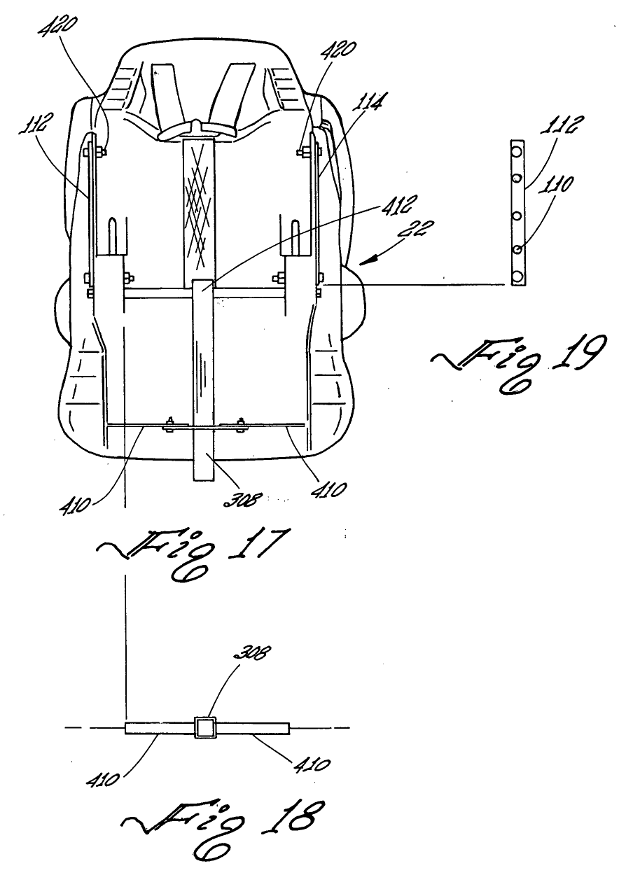

The rear elevational view of an infant seat carrier 22 is illustrated in FIG. 20. The infant seat carrier 22 has a back section 34 extending away from the seat section for supporting an elevated rear control handle 38 enabling a user to grasp, push and steer the combination infant seat carrier and detachable stroller support assembly. The elevated rear control handle 38 is extendable as shown by dashed lines 46 to increase the distance between the back section 34 of the infant seat carrier 22 and the handle 38.

As illustrated by FIGS. 1 through 6 and FIGS. 9 through 16, the stroller support structure may be fabricated from a tubular member. Usually, the tubular member is an extruded material, such as for example steel, plastic, PVC or the like. It is envisioned that any material capable of being extruded could be used for practicing the teachings of this invention. Of course, the stroller support structure could be fabricated of solid material, such as for example a solid wood member, a solid plastic member or the like.

The use of tubular material is prefers as the open central area results in a reduction of the weight of the stroller support structure while providing the desired structural integrity and strength.

The tubular material which may be used in practicing this invention may have any one of a number of cross-section configurations.

FIG. 21 is a pictorial representation of the cross-section of a tubular member 500 configured for use as a frame member in stroller support structure of the present invention wherein the cross-section is square-shaped and is defined by thin outer wall 502.

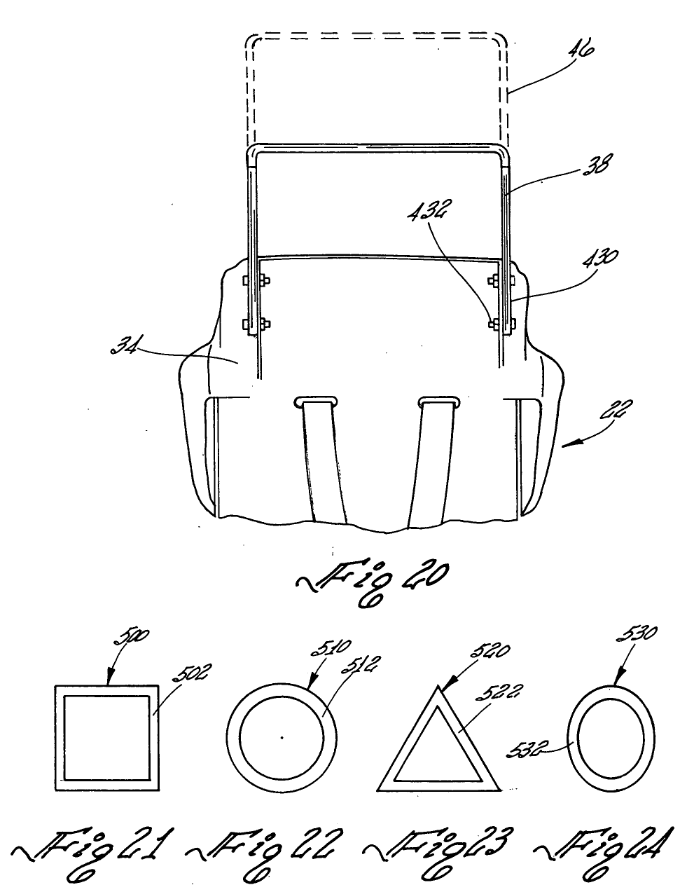

FIG. 22 is a pictorial representation of the cross-section of another form of tubular member 510 configured for use as a frame member in stroller support structure of the present invention wherein the cross-section is circular and is defined by thin outer wall 5122.

FIG. 23 is a pictorial representation of the cross-section of another form of tubular member 520 configured for use as a frame member in stroller support structure of the present invention wherein the cross-section is triangular and is defined by thin outer wall 522.

FIG. 24 is a pictorial representation of the cross-section of another form of tubular member 530 configured for use as a frame member in stroller support structure of the present invention wherein the cross-section is oblong and is defined by thin outer wall 532.

By utilizing the teachings of the present invention, a method for attaching an infant set carrier to a stroller support structure is disclosed. The method comprises the steps of: (i) forming a detachable stroller support structure for removeably receiving an infant seat carrier wherein the stroller support structure has a first frame member having an end configured to receive and support a front wheel and a second frame member having an arm member having a pair of ends wherein each of the pair of ends is configured to receive and support a rear support wheel and wherein the second frame member has a fixed coupling member positioned on the second frame member and spaced a predetermined distance from one of the pair of ends for cooperating with a first seat attachment member located at a predetermined location on a first side portion of a seat section of an infant seat carrier to be removeably attached thereto and a moveable coupling member positioned on the second frame member and spaced a predetermined distance from the other of the pair of ends for cooperating with a second seat attachment member located at a predetermined location on a second side portion of a seat section of an infant seat carrier and wherein the second frame member enables the first attachment member to cooperate with the second attachment member to fixedly connect the infant seat carrier to the second frame member and wherein the second frame member concurrently enables the fixed coupling member to cooperate with the first side attachment member and the moveable connecting member to cooperate with the second side attachment member to fixedly connect the infant seat carrier to the second frame member and wherein at least one of the first frame member or the second frame member has a first attachment member attaching a forward portion of a seat section of an infant seat carrier; (ii) attaching the at least one of the first frame member or the second frame member to the seat section of the infant seat carrier using the first attachment member to connect the seat section of an infant seat carrier to the second frame member; (iii) attaching the second frame member to the seat section of an infant seat carrier by connecting engagement of the fixed coupling member to the first seat attachment member located on the first side portion of a seat section of an infant seat carrier removeably attaching the first side portion of the infant seat carrier to the second frame member; and (iv) moving the moveable coupling member relative to the second frame member and to the second seat attachment member located on the second side portion of a seat section of an infant seat carrier to enable the seat section to contact the second frame member and then retrograding the moveable coupling member into connecting engagement with the second side portion of the infant seat carrier to the second frame member removeably attaching the first side portion of the infant seat carrier to the second frame member.

The method may further comprising the step of removeably attaching a front wheel to said first frame member. Also, the method may further comprising the step of removeably attaching a rear support wheel to each end of said second frame member.

Also disclosed is a method for using an infant set carrier with a stroller support structure. This method comprises the steps of: (i) forming a detachable stroller support structure for removeably receiving an infant seat carrier wherein the stroller support structure has a first frame member having an end configured to receive and support a front wheel and a second frame member having a first attachment member positioned on a central member of the first frame member and spaced a predetermined distance from a selected end thereof for cooperating with a second attachment member located at a predetermined location on a forward portion of a seat section of an infant seat carrier to be attached thereto an arm member having a pair of ends wherein each of the pair of ends is configured to receive and support a rear support wheel and wherein the second frame member has a fixed coupling member positioned on the second frame member and spaced a predetermined distance from one of the pair of ends for cooperating with a first seat attachment member located at a predetermined location on a first side portion of a seat section of an infant seat carrier to be removeably attached thereto and a moveable coupling member positioned on the second frame member and spaced a predetermined distance from the other of the pair of ends for cooperating with a second seat attachment member located at a predetermined location on a second side portion of a seat section of an infant seat carrier and wherein the second frame member enables the first attachment member to cooperate with the second attachment member to fixedly connect the infant seat carrier to the second frame member and wherein the second frame member concurrently enables the fixed coupling member to cooperate with the first side attachment member and the moveable connecting member to cooperate with the second side attachment member to fixedly connect the infant seat carrier to the second frame member; (ii) attaching the second frame member to the seat section of the infant seat carrier by enabling the first attachment member to cooperate with the second attachment member to fixedly connect the seat section of an infant seat carrier to the second frame member; (iii) attaching the second frame member to the seat section of an infant seat carrier by connecting engagement of the fixed coupling member to the first seat attachment member located on the first side portion of a seat section of an infant seat carrier removeably attaching the first side portion of the infant seat carrier to the second frame member; and (iv) moving the moveable coupling member relative to the second frame member and to the second seat attachment member located on the second side portion of a seat section of an infant seat carrier to enable the seat section to contact the second frame member and then retrograding the moveable coupling member into connecting engagement with the second side portion of the infant seat carrier to the second frame member removeably attaching the first side portion of the infant seat carrier to the second frame member.

The method may also comprise the step of removeably attaching a front wheel to said first frame member. Also, the method may further comprising the step of removeably attaching a rear support wheel to each end of the second frame member.

The method may also comprise having a first frame member pivotally connected to the second frame member and the method may further comprise the steps of: (i) removing the infant seat carrier from the stroller support structure; and (ii) rotating the first frame member relative to and positioned substantially in parallel with the second frame member to facilitate storage of the stroller support structure.

The method may also comprise having the first frame member telescopically connected to and slideable within the second frame member and the method may further comprise the steps of: (i) removing said infant seat carrier from the stroller support structure; and (ii) sliding the first frame member relative to and within the second frame member forming a telescoped first frame member within the second frame member to facilitate storage of the stroller support structure.

It is envisioned that the stroller support structure can be used with most infant seat carries meeting the United States Department of Transportation Rules and Regulations by modifying or adding components to the infant seat carrier as disclosed and taught herein. The first frame member and the second frame member can be configured to accommodate most infant seat carrier configurations such the infant seat carrier can be removeably attached to a stroller support structure having a first frame member and/or a second frame member or equivalents thereof. This invention may be used in substantially the configuration of the preferred embodiment or of the disclosd alternate embodiments or variations thereof. It will be appreciated that various alterations and modifications may be made to stroller support structure to enhance the functional characteristics thereof. All such variations and modifications should be considered to fall within the scope of the invention as broadly hereinbefore described and as claimed hereafter.

All such uses, variations, modifications and the like are anticipated to be within the scope of this invention.

What is claimed is:

1. A detachable stroller support structure for removeably receiving an infant seat carrier comprising
a first frame member having an end configured to receive and support a front wheel assembly;
a second frame member having an arm member having a pair of ends wherein each of said pair of ends is configured to receive and support a rear support wheel, said second frame member having a fixed coupling member positioned on the arm member of said second frame member and spaced a predetermined distance from one of said pair of ends for cooperating with a first seat attachment member located at a predetermined location on a first side portion of a seat section of an infant seat carrier to be removeably attached thereto and a moveable coupling member positioned on the arm member of said second frame member and spaced a predetermined distance from the other of said pair of ends for cooperating with a second seat attachment member located at a predetermined location on a second side portion of a seat section of an infant seat carrier; and
at least one of said first frame member or said second frame member having a first attachment member positioned thereon for connecting the at least one of said first frame member or said second frame member to a forward portion of a seat section of an infant seat carrier to attach the infant seat carrier thereto.

2. The detachable stroller support structure of claim 1 wherein said second frame member concurrently enables said fixed coupling member to cooperate with said first side attachment member and said moveable connecting member to cooperate with said second side attachment member to fixedly connect the infant seat carrier to said second frame member.

3. The detachable stroller support structure of claim 1 wherein said first frame member has the first attachment member which is fixedly attached to a forward portion of a seat section of an infant seat carrier to attach the infant seat carrier to thereto.

4. The detachable stroller support structure of claim 1 wherein said second frame member has the first attachment member positioned thereon and spaced at a predetermined location from a selected end thereof for cooperating with a second attachment member located on a forward portion of a seat section of an infant seat carrier to attach the infant seat carrier to thereto.

5. The detachable stroller support structure of claim 1 wherein said first frame member is integral with the seat portion of an infant seat carrier.

6. The detachable stroller support structure of claim 1 wherein said second frame member is detachable from the seat portion of an infant seat carrier.

7. The detachable stroller support structure of claim 1 wherein said first frame member is configured to receive and support a detachable front wheel in a fixed position.

8. The detachable stroller support structure of claim 1 wherein each end of the pair of ends of the arm member of said second frame member is configured to receive and support a detachable rear support wheel.

9. The detachable stroller support structure of claim 8 wherein said each end of the pair of ends of the arm member of said second frame is configured to receive and support a detachable rear support wheel having a selected diameter and wherein the detachable front wheel has a diameter which is smaller than the selected diameter.

10. The detachable stroller support structure of claim 1 wherein said first frame member is pivotally mounted to said second frame member and enabling said first frame member to be rotated relative to and positioned substantially in parallel with said second frame member to facilitate storage of the stroller support structure.

11. The detachable stroller support structure of claim 10 wherein said first frame member includes a front wheel in a fixed position and positioned on said first frame member so as to extend away from said second frame member when said first frame member is rotated to be substantially in parallel with said second frame member to facilitate storage of the stroller support structure.

12. The detachable stroller support structure of claim 1 wherein said first frame member is telescopically mounted to said second frame member and enabling said first frame member to be transported into and slideable within said second frame member to facilitate storage of the stroller support structure.

13. The detachable stroller support structure of claim 12 wherein said first frame member includes a front wheel in a fixed position and positioned on said first frame member so as to extend away from said second frame member when said first frame member is transported within said second frame member to form a telescoped first frame member within said second frame member to facilitate storage of the stroller support structure.

14. In combination,
an infant seat carrier having a seat section, said seat section having a forward portion and a pair of opposed side portions; and
a detachable stroller support structure for removeably receiving an infant seat carrier comprising
a first frame member having an end configured to receive and support a front wheel; and
a second frame member having an extended arm member having a pair of ends wherein each of said pair of ends is configured to receive and support a rear support wheel, said second frame member having a fixed coupling member positioned on the extended arm member of said second frame member and spaced a predetermined distance from one of said pair of ends for cooperating with a first seat attachment member located at a predetermined location on a first side portion of a seat section of an infant seat carrier to be removeably attached thereto and a moveable coupling member positioned on the extended arm member of said second frame member and spaced a predetermined distance from the other of said pair of ends for cooperating with a second seat attachment member located at a predetermined location on a second side portion of a seat section of an infant seat carrier; and
at least one of said first frame member or said second frame member having a first attachment member positioned thereon for connecting the at least one of said first frame member or said second frame member to a forward portion of a seat section of an infant seat carrier to attach the infant seat carrier thereto.

15. The detachable stroller support structure of claim 14 wherein said second frame member concurrently enables said fixed coupling member to cooperate with said first side attachment member and said moveable connecting member to cooperate with said second side attachment member to fixedly connect the infant seat carrier to said second frame member.

16. The detachable stroller support structure of claim 14 wherein said first frame member has the first attachment member and is fixedly attached to a forward portion of a seat section of an infant seat carrier to attach the infant seat carrier to thereto.

17. The detachable stroller support structure of claim 14 wherein said second frame member has the first attachment member positioned thereon and spaced at a predetermined location from a selected end thereof for cooperating with a second attachment member located on a forward portion of a seat section of an infant seat carrier to attach the infant seat carrier to thereto.

18. In combination,
an infant seat carrier having a seat section, said seat section having a forward portion and a pair of opposed side portions; and
a detachable stroller support structure for removeably receiving an infant seat carrier comprising
a first frame member having an end configured to receive and support a front wheel, said first frame member having a first attachment member for connecting the first frame member to a forward portion of a seat section of an infant seat carrier to attach the infant seat carrier thereto;
a second frame member having an extended arm member having a pair of ends wherein each of said pair of ends is configured to receive and support a rear support wheel, said second frame member having a fixed coupling member positioned on said second frame member and spaced a predetermined distance from one of said pair of ends for cooperating with a first seat attachment member located at a predetermined location on one of the side portions of the seat section of said infant seat carrier to be removeably attached thereto and a moveable coupling member positioned on said second frame member and spaced a predetermined distance from the other of said pair of ends for cooperating with a second seat attachment member located at a predetermined location on the other of the pair of the side portions of the seat section of said infant seat carrier;
and wherein said second frame member concurrently enables said fixed coupling member to cooperate with said first side attachment member to fixedly connect said infant seat carrier to said second frame member and said moveable connecting member is moveable relative to said second frame member between an open and locked position and when said moveable coupling member is in its locked position cooperates with said second side attachment member to fixedly connect the infant seat carrier to said second frame member.

19. The detachable stroller support structure of claim 18 wherein said first frame member is configured to receive and support a detachable front wheel in a fixed position.

20. The detachable stroller support structure of claim 18 wherein each end of the elongated arm member of said second frame member is configured to receive and support a detachable rear support wheel.

21. In combination,
an infant seat carrier having a seat section, said seat section having a forward portion and a pair of opposed side portions; and
a detachable stroller support structure for removeably receiving an infant seat carrier comprising
a first frame member having an end configured to receive and support a front wheel; and
a second frame member having a having a first attachment member positioned on an elongated central member and spaced a predetermined distance from a selected end thereof for cooperating with a second attachment member located at a predetermined location on the forward portion of said seat section of an infant seat carrier to be removeably attached thereto and a pair of ends located on an extended arm member wherein each of said pair of ends is configured to receive and support a rear support wheel, said second frame member having a fixed coupling member positioned on said second frame member and spaced a predetermined distance from one of said pair of ends for cooperating with a first seat attachment member located at a predetermined location on one of the side portions of the seat section of said infant seat carrier to be removeably attached thereto and a moveable coupling member positioned on said second frame member and spaced a predetermined distance from the other of said pair of ends for cooperating with a second seat attachment member located at a predetermined location on the other of the pair of the side portions of the seat section of said infant seat carrier;
said second member enabling said first attachment member to cooperate with said second attachment member to fixedly connect the infant seat carrier to said second frame member and wherein said second frame member concurrently enables said fixed coupling member to cooperate with said first side attachment member to fixedly connect said infant seat carrier to said second frame member and said moveable connecting member is moveable relative to said second frame member between an open and locked position and when said moveable coupling member is in its locked position cooperates with said second side attachment member to fixedly connect the infant seat carrier to said second frame member.

22. The combination of claim 21 wherein said first frame member is integral with the seat portion of an infant seat carrier.

23. The detachable stroller support structure of claim 21 wherein said second frame member is detachable from the seat portion of an infant seat carrier.

24. The detachable stroller support structure of claim 21 wherein said first frame member is configured to receive and support a detachable front wheel in a fixed position.

25. The detachable stroller support structure of claim 21 wherein each end of the elongated arm member of said second frame member is configured to receive and support a detachable rear support wheel.

26. The detachable stroller support structure of claim 25 herein said each end of the elongated arm member of said second frame member is configured to receive and support a detachable rear support wheel having a selected diameter and wherein the detachable front wheel has a diameter which is smaller than the selected diameter.

27. The detachable stroller support structure of claim 21 herein said first frame member is pivotally mounted to said second frame member and enabling said first frame member to be rotated relative to and positioned substantially in parallel with said second frame member to facilitate storage of the stroller support structure.

28. The detachable stroller support structure of claim 27 wherein said first frame member includes a front wheel in a fixed position and positioned on said first frame member so as to extend away from said second frame member when said first frame member is rotated to be substantially in parallel with said second frame member to facilitate storage of the stroller support structure.

29. The detachable stroller support structure of claim 21 wherein said first frame member is telescopically mounted to said second frame member and enabling said first frame member to be transported into and within said second frame member to facilitate storage of the stroller support structure.

30. The detachable stroller support structure of claim 29 wherein said first frame member includes a front wheel in a fixed position and positioned on said first frame member so as to extend away from said second frame member when said first frame member is transported within said second frame member to form a telescoped first frame member within said second frame member to facilitate storage of the stroller support structure.

31. The combination of claim 21 wherein the first attachment member located on said second frame member is an extended boss member and said second attachment member on the forward portion of the seat section of an infant seat carrier is an opening sized to receive and support the extended boss member.

32. The combination of claim 21 wherein said infant seat carrier has a back section extending away from said seat section and wherein said combination further comprises
an elevated rear control handle enabling a user to grasp, push and steer the combination infant seat carrier and detachable stroller support assembly.

33. The combination of claim 32 wherein said elevated rear control handle is extendable to increase the distance between the back section of the infant seat carrier and the handle.

34. A stroller comprising a removeable infant seat carrier having a seat section having a forward portion and a pair of opposed side portions, said stroller comprising
a detachable stroller support structure for removeably receiving said infant seat carrier, said detachable stroller support structure comprising
a first frame member having an end configured to receive and support a front wheel;
a second frame member having an elongated central member and an extended arm member having a pair of ends wherein each of said pair of ends is configured to receive and support a rear support wheel, said second frame member having a fixed coupling member positioned on the arm member of said second frame member and spaced a predetermined distance from one of said pair of ends for cooperating with a first seat attachment member located at a predetermined location on a first side portion of a seat section of an infant seat carrier to be removeably attached thereto and a moveable coupling member positioned on the arm member of said second frame member and spaced a predetermined distance from the other of said pair of ends for cooperating with a second seat attachment member located at a predetermined location on a second side portion of a seat section of an infant seat carrier;
at least one of said first frame member or said second frame member having a first attachment member positioned thereon for connecting the at least one of said first frame member or said second frame member to a forward portion of a seat section of an infant seat carrier to attach the infant seat carrier thereto, and wherein said second frame member concurrently enables said fixed coupling member to cooperate with said first side attachment member and said moveable connecting member to cooperate with said second side attachment member to fixedly connect the infant seat carrier to said second frame member;
a detachable front wheel in a fixed position fixedly attached to said first frame member; and
detachable rear wheels removeable attached to each end of said second frame member.

35. A method for attaching an infant set carrier to a stroller support structure comprising the steps of
forming a detachable stroller support structure for removeably receiving an infant seat carrier wherein said stroller support structure has a first frame member having an end configured to receive and support a front wheel and a second frame member having an arm member having a pair of ends wherein each of said pair of ends is configured to receive and support a rear support wheel and wherein said second frame member has a fixed coupling member positioned on said second frame member and spaced a predetermined distance from one of said pair of ends for cooperating with a first seat attachment member located at a predetermined location on a first side portion of a seat section of an infant seat carrier to be removeably attached thereto and a moveable coupling member positioned on said second frame member and spaced a predetermined distance from the other of said pair of ends for cooperating with a second seat attachment member located at a predetermined location on a second side portion of a seat section of an infant seat carrier and wherein said second frame member enables said first attachment member to cooperate with said second attachment member to fixedly connect the infant seat carrier to said second frame member and wherein said second frame member concurrently enables said fixed coupling member to cooperate with said first side attachment member and said moveable connecting member to cooperate with said second side attachment member to fixedly connect the infant seat carrier to said second frame member and wherein at least one of the first frame member or the second frame member has a first attachment member attaching a forward portion of a seat section of an infant seat carrier;
attaching said at least one of the first frame member or the second frame member to the seat section of the infant seat carrier using said first attachment member to connect the seat section of an infant seat carrier to said second frame member;
attaching said second frame member to the seat section of an infant seat carrier by connecting engagement of said fixed coupling member to said first seat attachment member located on the first side portion of a seat section of an infant seat carrier removeably attaching the first side portion of the infant seat carrier to the second frame member; and
moving said moveable coupling member relative to the second frame member and to said second seat attachment member located on the second side portion of a seat section of an infant seat carrier to enable the seat section to contact the second frame member and then retrograding the moveable coupling member into connecting engagement with the second side portion of the infant seat carrier to the second frame member removeably attaching the first side portion of the infant seat carrier to the second frame member.

36. The method of claim 35 further comprising the step of removeably attaching a front wheel to said first frame member.

37. The method of claim 35 further comprising the step of
removeably attaching a rear support wheel to each end of said second frame member.

38. A method for using an infant set carrier with a stroller support structure comprising the steps of
forming a detachable stroller support structure for removeably receiving an infant seat carrier wherein said stroller support structure has a first frame member having an end configured to receive and support a front wheel and a second frame member having a first attachment member positioned on a central member of said first frame member and spaced a predetermined distance from a selected end thereof for cooperating with a second attachment member located at a predetermined location on a forward portion of a seat section of an infant seat carrier to be attached thereto an arm member having a pair of ends wherein each of said pair of ends is configured to receive and support a rear support wheel and wherein said second frame member has a fixed coupling member positioned on said second frame member and spaced a predetermined distance from one of said pair of ends for cooperating with a first seat attachment member located at a predetermined location on a first side portion of a seat section of an infant seat carrier to be removeably attached thereto and a moveable coupling member positioned on said second frame member and spaced a predetermined distance from the other of said pair of ends for cooperating with a second seat attachment member located at a predetermined location on a second side portion of a seat section of an infant seat carrier and wherein said second frame member enables said first attachment member to cooperate with said second attachment member to fixedly connect the infant seat carrier to said second frame member and wherein said second frame member concurrently enables said fixed coupling member to cooperate with said first side attachment member and said moveable connecting member to cooperate with said second side attachment member to fixedly connect the infant seat carrier to said second frame member;
attaching said second frame member to the seat section of the infant seat carrier by enabling said first attachment member to cooperate with said second attachment member to fixedly connect the seat section of an infant seat carrier to said second frame member;
attaching said second frame member to the seat section of an infant seat carrier by connecting engagement of said fixed coupling member to said first seat attachment member located on the first side portion of a seat section of an infant seat carrier removeably attaching the first side portion of the infant seat carrier to the second frame member; and
moving said moveable coupling member relative to the second frame member and to said second seat attachment member located on the second side portion of a seat section of an infant seat carrier to enable the seat section to contact the second frame member and then retrograding the moveable coupling member into connecting engagement with the second side portion of the infant seat carrier to the second frame member removeably attaching the first side portion of the infant seat carrier to the second frame member.

39. The method of claim 38 further comprising the step of
removeably attaching a front wheel to said first frame member.

40. The method of claim 38 further comprising the step of
removeably attaching a rear support wheel to each end of said second frame member.

41. The method of claim 38 wherein said first frame member is pivotally connected to said second frame member, said method further comprising the steps of:
removing said infant seat carrier from said stroller support structure; and
rotating the first frame member relative to and positioned substantially in parallel with said second frame member to facilitate storage of the stroller support structure.

42. The method of claim 38 wherein said first frame member is telescopically connected to and slideable within said second frame member, said method further comprising the steps of:
removing said infant seat carrier from said stroller support structure; and
sliding the first frame member relative to and within said second frame member forming a telescoped first frame member within said second frame member to facilitate storage of the stroller support structure.
